(19) United States
(12) Patent Application Publication
(10) Pub. No.: US 2009/0158285 A1
(43) Pub. Date: Jun. 18, 2009

(54) APPARATUS AND METHOD FOR CONTROLLING RESOURCE SHARING SCHEDULE IN MULTI-DECODING SYSTEM

(75) Inventors: Mi Young Lee, Daejeon (KR); Han Jin Cho, Daejeon (KR)

Correspondence Address: AMPACC LAW GROUP, 13024 Beverly Park Road, Suite 205, Mukilteo, WA, 98275, US

(73) Assignee: Electronics and Telecommunications Research Institute, Daejeon (KR)

(21) Appl. No.: 12/239,508

(22) Filed: Sep. 26, 2008

(30) Foreign Application Priority Data
Dec. 17, 2007 (KR) 10-2007-0132319

(51) Int. Cl. G06F 9/46

(52) U.S. Cl. 718/102

(57) ABSTRACT

An apparatus for controlling a resource sharing schedule in a multi-decoding system including a multi-decoder formed of a plurality of resources, the apparatus including: a storage unit storing status information of the resources and information required in controlling the resource sharing schedule; and a controller, when a source resource requests assignment of a target resource, assigning the target resource, outputting information of the target resource to the source resource, and updating statuses of the resources, wherein the apparatus controls the resource sharing schedule while bidirectionally connected to the resources to share the resources between the multi-decoders. Accordingly, it is possible to reduce an overall decoding time and controlling a resource usage schedule.

### CROSS-REFERENCE TO RELATED APPLICATIONS

This application claims the priority of Korean Patent Application No. 2007-0132319 filed on Dec. 17, 2007, in the Korean Intellectual Property Office, the disclosure of which is incorporated herein by reference.

### BACKGROUND OF THE INVENTION

1. Field of the Invention

The present invention relates to a multi-decoding system, and more particularly, to an apparatus and a method for controlling a resource sharing schedule in a multi-decoding system simultaneously performing a plurality of decoding operations.

The present invention was supported by the IT R&D program of MIC/IITA [2005-S-077-03, Development of On-Chip Network Based SoC Platform].

2. Description of the Related Art

In general, in the case of a bus method used as an interconnection method in a System-on-Chip (SoC) design, due to sharing one medium such as a bus, not only communication between components is slow but also it is difficult to extend due to using an arbiter for bus access authority distribution. To overcome such defects, recently, researches on Network-on-Chip (NoC) capable of extending and executing parallel data communication have been performed.

FIG. 1 illustrates an example of a system using the NoC method. The system using the NoC method is a system for interconnection among components in an SoC design field, such as processors, memories, and hardware.

Referring to FIG. 1, the system using the NoC method includes a switch 10 to which one resource or a module 20 is connected. The switch 10 includes five input/output ports. Input data is transferred to a destination by a determined routing algorithm. A request for transmitting two or more input port data to an output port is processed by an arbiter algorithm such as round robin and priority methods. Buffering functions are embodied for a case of network congestion. The switches 10 are connected to one another by a bidirectional link 30.

FIG. 2 is a diagram illustrating a general multi-decoding system embodied by NoC interconnection, which is embodied by a plurality of encoders or video decoders using extendibility of the NoC. In FIG. 2, blocks 41 and 42 of dotted lines are made by grouping modules forming each decoder.

Generally, one decoder includes a motion compensation module MC, an entropy decoding module Ent.Dec, de-blocking module DB, and an inverse transformation and inverse quantization module ITIQ.

However, in the case of modules forming a general decoder, according to an encoding mode of a video that should be decoded by the decoder, due to a great difference between complexities of operations thereof, an operation time is irregular and variable. For example, in the case of the motion compensation module MC, when a motion vector is located in an integer pixel, a certain portion of input data is outputted as it is and operation is finished. On the other hand, when the motion vector is located at a ¼ pixel, since a result is obtained by taking an interpolation using a 6 tap filter, an operation time becomes longer.

When an operation time of the motion compensation module MC of the decoder 41 becomes longer while modules are regularly assigned to the decoder 41 in the multi-video decoding system, the entropy decoding module Ent.Dec executing a decoding operation previous to that of the motion compensation module MC should immediately transfer and wait for an end of the operation of the motion compensation module MC, incapable of executing a next decoding operation.

Different from a case of regularly assigning modules to one decoder in a conventional method, to reduce an overall operation time by reducing a standby time of modules in the decoder, a plurality of decoders should share modules. That is, the plurality of decoders share modules, when using AA module performing a different mode decoding and early finishing operation among modules corresponding to A function, since B module has no need to consume a time for standby, the overall operation time may be reduced.

### SUMMARY OF THE INVENTION

An aspect of the present invention provides an apparatus and a method for controlling a resource sharing schedule in a multi-video decoding system in which a plurality of resources or modules performing the same operation are present and a plurality of decoding operations are performed simultaneously, the method capable of controlling a module using schedule by using variable length operation characteristics of modules included in a video decoder by applying a Network-on-Chip (NoC) data transmission method.

According to an aspect of the present invention, there is provided a resource sharing apparatus for controlling a resource sharing schedule in a multi-decoding system including a multi-decoder formed of a plurality of resources, the apparatus including: a storage unit storing status information of the resources and information required in controlling the resource sharing schedule; and a controller, when a source resource requests assignment of a target resource, assigning the target resource, outputting information of the target resource to the source resource, and updating statuses of the resources, wherein the resource sharing apparatus controls the resource sharing schedule while bidirectionally connected to the resources to share the resources between the multi-decoders.

According to another aspect of the present invention, there is provided a method of controlling a resource sharing schedule in a multi-video decoding system including a multi-decoder formed of a plurality of resources and an apparatus for controlling the resource sharing schedule, the method including: initializing a resource status for each resource and for each operation mode, stored in a storage unit, and information for controlling the resource sharing schedule; assigning a target resource when a source resource requests assignment of the target resource; and updating the resource status stored in the storage unit when the source resource requests status update.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram illustrating a configuration of a general Network-on-Chip (NoC) data transmission type system;

FIG. 2 is a diagram illustrating a general multi-decoding system embodied by NoC interconnection;

FIG. 3 is a diagram illustrating a configuration of an NoC-based multi-decoding system according to an exemplary embodiment of the present invention;

FIG. 4 is a diagram illustrating an internal configuration of an apparatus for controlling resource sharing schedule in the multi-decoding system, according to an exemplary embodiment of the present invention;

FIG. 5 is a diagram illustrating operations of controlling the resource sharing schedule at the apparatus for controlling the resource sharing schedule, according to an exemplary embodiment of the present invention;

FIG. 6 is a flowchart illustrating a process of assigning a target resource according to an exemplary embodiment of the present invention; and

FIG. 7 is a flowchart illustrating a process of updating a resource status according to a status update request, according to an exemplary embodiment of the present invention.

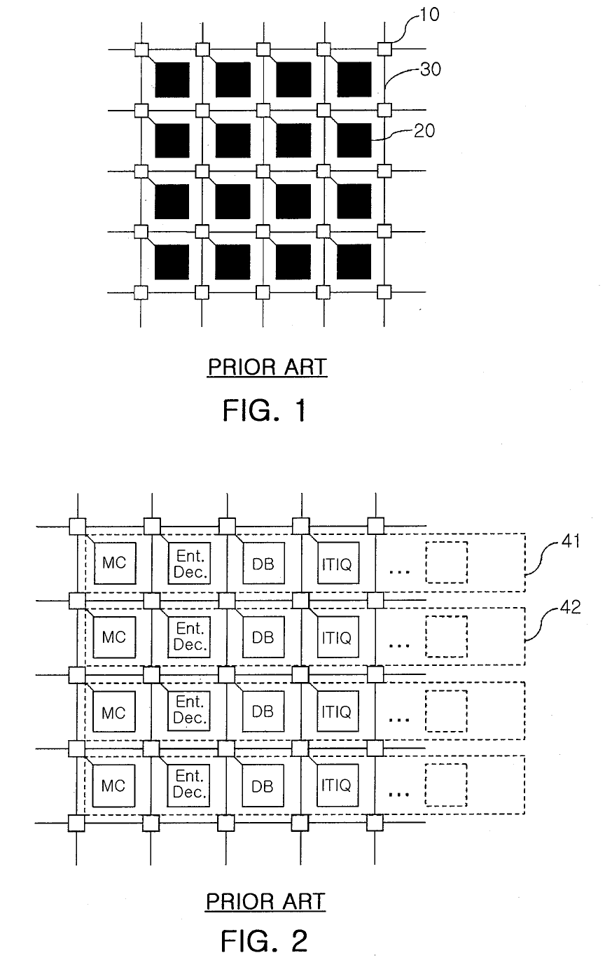

### DETAILED DESCRIPTION OF THE PREFERRED EMBODIMENT

Exemplary embodiments of the present invention will now be described in detail with reference to the accompanying drawings. Only, in describing operations of the exemplary embodiments in detail, when it is considered that a detailed description on related well-known functions or constitutions unnecessarily may make essential points of the present invention be unclear, the detailed description will be omitted.

An apparatus for controlling a resource sharing schedule in a multi-decoding system, according to an exemplary embodiment of the present invention will be described in detail with reference to the attached drawings. In this case, the multi-decoding system employs a Network-on-Chip (NoC) data transmission method.

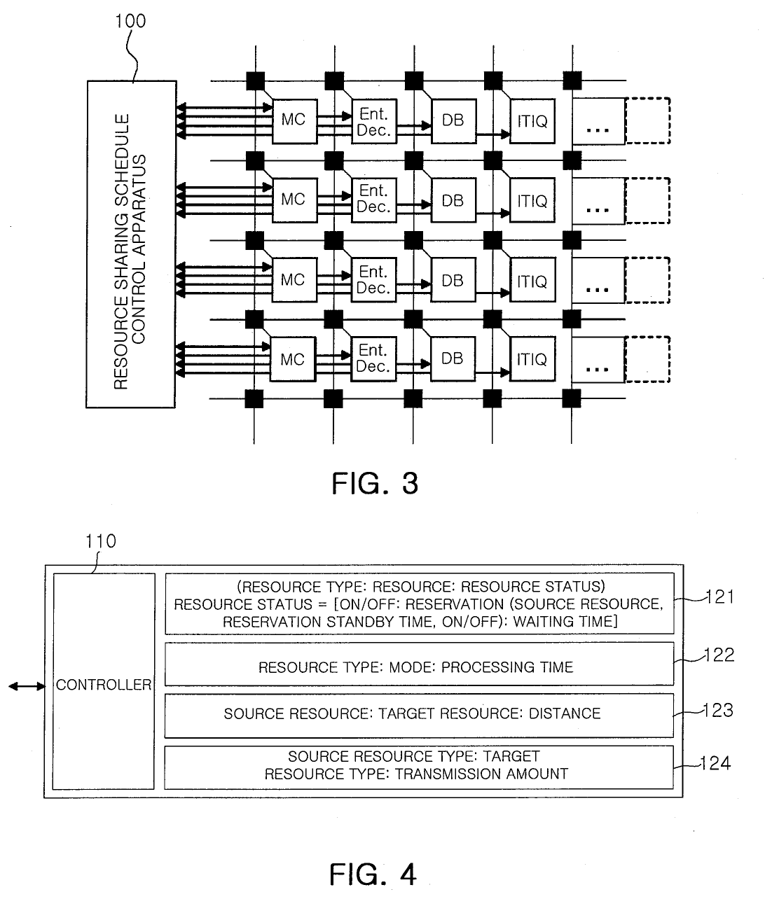

FIG. 3 is a diagram illustrating a configuration of an NoC-based multi-decoding system according to an exemplary embodiment of the present invention. FIG. 4 is a diagram illustrating an internal configuration of a resource sharing schedule control apparatus 100 in the multi-decoding system, according to an exemplary embodiment of the present invention.

The multi-decoding system may include a multi-decoder formed of a plurality of resources or modules and the resource sharing schedule control apparatus 100. In this case, the multi-decoder may be a plurality of video decoders. Each of the video decoders, as shown in FIG. 2, is formed of a plurality of grouped resources connected by a switch 10.

The resource sharing schedule apparatus 100 is bidirectionally connected to all of the resources forming the multi-decoding system to share resources and assigns a resource available for a shortest period during decoding operation in such a way that the multi-decoder shares a resource having the same function to perform encoding. The resource sharing schedule control apparatus 100, as shown in FIG. 4, may include a controller 110 and a storage unit.

The controller 110, when a source resource requests assignment of a target resource to share, selects the resource available for a shortest period among encoding operations, reserves and assigns the selected resource to the target resource, and outputs information on the target resource to the source resource. The controller 110, when receiving a status update request from a source resource, updates a resource status stored in the storage unit.

The storage unit includes a resource status storage 121, an expected processing time recorder 122, an inter-resource distance recorder 123, and a transmission amount recorder 124, to store status information of the resources and information required in controlling a sharing schedule of the resources.

For each resource type such as a motion compensation (MC) module and a de-blocking (DB) module, for example, with respect to an MC function, as MC modules shown in FIG. 3, the resource status storage 121 stores a resource status for a resource having the MC function, included in the system. The resource status storage 121 is divided into a resource type area, a resource area, and a resource status area. The resource status area is divided into an operation status area (on/off), a reservation area (a source resource, a waiting time, and a reservation status (on/off)), and a waiting time area.

The expected processing time recorder 122 is divided into a resource type area, a mode area, and a processing time area and records expected processing times for each resource type and for each encoding mode.

The inter-resource distance recorder 123 is divided into a source resource area, a target resource area, and a distance area and records the number of hops between the resources, that is, the least number of switches to be passed while performing inter-module communication. For example, a distance between an MC module and a DB module in FIG. 3 may be recorded as two hops.

The transmission amount recorder 124 is divided into a source resource type area, a target resource type area, and a transmission amount area and records a transmission amount between a source resource and a target resource according to a resource type.

A method of controlling a resource sharing schedule at the resource sharing schedule control apparatus will be described in detail with reference to the attached drawings.

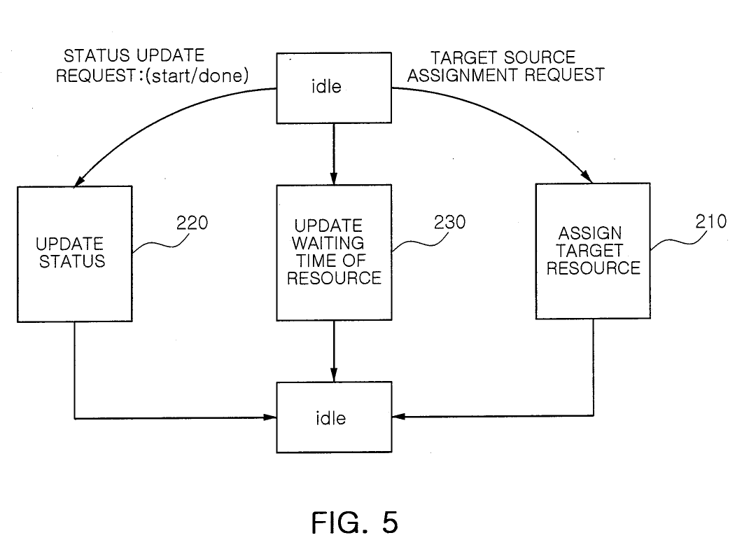

FIG. 5 is a diagram illustrating operations for controlling a resource sharing schedule at the resource sharing schedule control apparatus 100, according to an exemplary embodiment of the present invention.

Previously, it is assumed that each video decoder included in the multi-decoding system requests the resource sharing schedule control apparatus 100 of the resource assignment when assignment of a next resource is required. The resource sharing schedule control apparatus 100 is initialized as follows.

The resource status storage 121 sets a resource status as off and sets a reservation as off, with respect to all resources for each resource type.

The expected processing time recorder 122 measures an operation cycle with respect to available modes for each resource type by measuring operation characteristics of a resource and records a result of measurement.

The inter-resource distance recorder 123 records the number of hops between one another resources according to an NoC configuration. The transmission amount recorder 124 records a transmission amount with respect to all target resources for each resource type and for each available mode.

Referring to FIG. 5, in 200, the controller 110 of the resource sharing schedule control apparatus 100, when receiving a target resource assignment request from a resource requiring assignment of a next resource in an idle status, assigns a target resource. In this case, occasionally, target resource information is outputted to a source resource. After the assigning the target resource, the resource sharing schedule control apparatus 100 is turned to an idle status.

In 210, when a resource finishes operation and informs a change of a status, the resource sharing schedule control apparatus 100 outputs target resource information to a reserved source resource when the resource is reserved. On the other hand, when the resource starts operation and informs a change of a status, that is, when the resource receives data from the source resource and starts operation, the resource sharing schedule control apparatus 100 initializes a reservation standby time from the resource status storage 121 as a waiting time and sets a reservation status as off and an operation status as on.

In 220, the resource sharing schedule control apparatus 100 updates a waiting time of a resource whose operation status is on.

The process of controlling a resource sharing schedule will be described in detail.

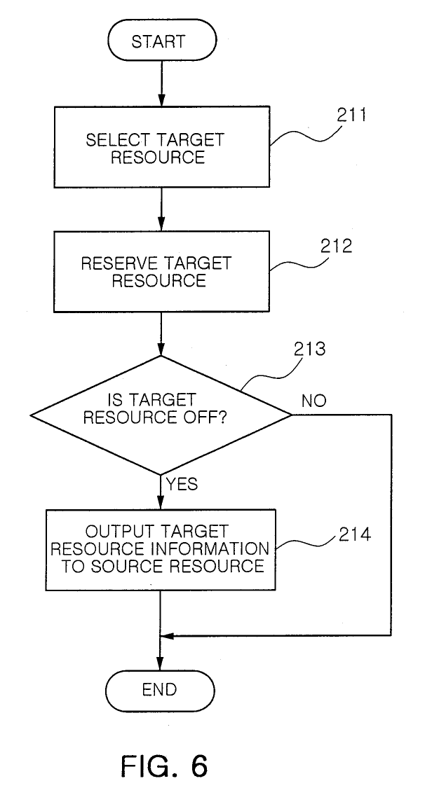

FIG. 6 is a flowchart illustrating a process of assigning a target resource according to an exemplary embodiment of the present invention.

Referring to FIG. 6, though before a module finishes operation, when resource assignment is required to a next encoding operation, the module requests the resource sharing schedule control apparatus 100 of target resource assignment together with a type of a resource desired to be assigned and a desired operation mode. Accordingly, in 211, the controller 110 of the resource sharing schedule control apparatus 100 receives a target resource assignment request and selects a target resource. That is, the controller 110 checks a resource status for each target type in the resource status storage 121 and selects a resource with a least ‘cost function’ in following Equation 1 among resources whose status is off or whose status is on while a reservation status thereof is off, as the target resource.

Cost function=expected transmission time+expected waiting time Equation (1)

In Equation 1, the expected transmission time may be obtained by multiplying a distance value between a source resource and a target resource, recorded in the inter-resource distance recorder 123, a transmission time value for each hop, and a transmission amount value from the source resource to the target resource in a corresponding mode, recorded in the transmission amount recorder 123. The waiting time is an expected waiting time to use the resource when a status is on. On the other hand, when the status is off, the waiting time is 0.

In 212, the controller 110 sets a reservation status among resource statuses of an area corresponding to the selected target resource information in the resource status storage 121 and reserves a target resource. That is, a reserved source resource is set as a requesting source resource and the reservation waiting time is set by extracting an expected processing time of a requested operation mode from the expected processing time recorder 122 and sets a reservation as an on status.

In 213, the controller 110 checks whether a status of the selected target resource, set in the resource status storage 121, is off. That is, excluding a case in which the status is on and it is impossible to immediately use, that is, the status is off and it is possible to immediately use. When the status is not off, operations are finished. When the status is off, in 214, the controller 110 outputs information on the target resource, such as an address thereof, to the requesting source resource and finishes operation.

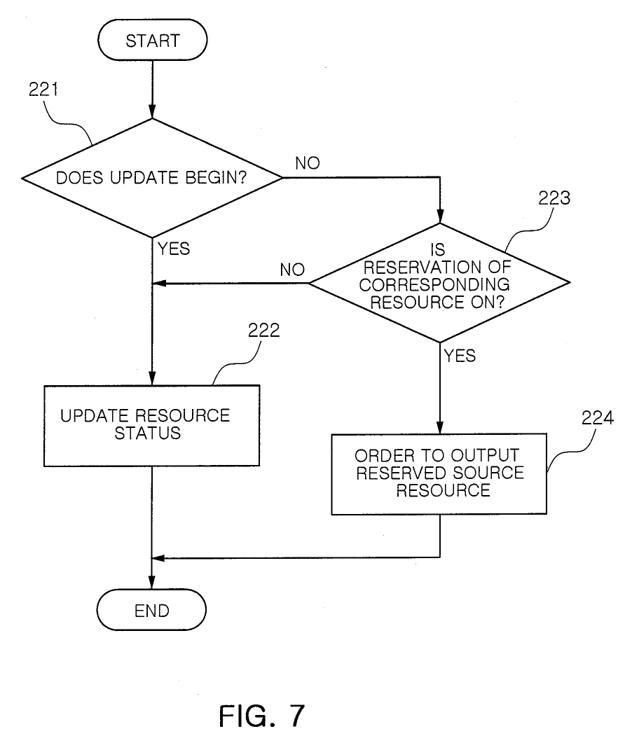

FIG. 7 is a flowchart illustrating a process of updating a resource status according to a status update request, according to an exemplary embodiment of the present invention.

When a module requests status update to inform a change of a status at a point in time of finishing operation or beginning operation by receiving input for the operation, in 221, the controller 110 checks a request type and performs operation of 222 when update beginning is shown.

In 222, the controller 110 checks a reservation status in the resource status storage 121, sets a reservation standby time as a waiting time, changes a resource status into on by setting a reservation status as off, and finishes operation.

On the other hand, as a result of the checking in 221, when an end is shown instead of the update beginning, in 223, the controller 110 checks whether the resource is reserved and performs 224 when a reservation is performed. In this case, the resource status storage 121 changes an operation status into off.

In 224, the controller 110 controls to start data transmission by ordering to output information of the target resource, such as an address thereof, to the reserved source resource and finishes operation. On the other hand, when the resource is not reserved, the controller 110 updates the resource status by performing operation of 222.

In 220, an expected waiting time that is a time for waiting until a module whose status is on finishes operation is updated according to a clock and an initial value of the waiting time, which is applied as an expected processing time when the module starts in 222, is reduced by one for each clock.

While the present invention has been shown and described in connection with the exemplary embodiments, it will be apparent to those skilled in the art that modifications and variations can be made without departing from the spirit and scope of the invention as defined by the appended claims.

What is claimed is:

1. A resource sharing apparatus for controlling a resource sharing schedule in a multi-decoding system including a multi-decoder formed of a plurality of resources, the apparatus comprising:
a storage unit storing status information of the resources and information required in controlling the resource sharing schedule; and
a controller, when a source resource requests assignment of a target resource, assigning the target resource, outputting information of the target resource to the source resource, and updating statuses of the resources,
wherein the resource sharing apparatus controls the resource sharing schedule while bidirectionally connected to the resources to share the resources between the multi-decoders.

2. The apparatus of claim 1, wherein the storage unit comprises:
a resource status storage classifying the resources for each type and storing resource statuses;
an expected processing time recorder recording an expected processing time for each resource type;
an inter-resource distance recorder recording a distance between the resources by a number of hops of switches connecting the resources; and
a transmission amount recorder recording a transmission amount between the source resource and the target resource according to the resource type.

3. The apparatus of claim 2, wherein the controller checks the resource status stored in the resource status storage, selects a resource available for a shortest period during decoding operation, and reserves the selected resource, and assigns the reserved resource to the target resource.

4. The apparatus of claim 3, wherein the controller, when a reservation status of the resource status is off, selects a resource having a least time obtained by adding an expected transmission time and an expected standby time, as the resource available for the shortest period.

5. The apparatus of claim 4, wherein the expected transmission time is obtained by multiplying the distance between the source resource and the target resource, a transmission time for each of the hops, and the transmission amounts recorded in the transmission amount recorder.

6. The apparatus of claim 3, wherein the controller sets the requested source resource as a reserved source resource, extracts an expected processing time for a requested operation mode from the expected processing time recorder, sets the extracted expected processing time as a reservation standby time, sets a reservation status as on, and sets a resource status area of the resource status storage, thereby reserving the selected resource.

7. A method of controlling a resource sharing schedule in a multi-video decoding system including a multi-decoder formed of a plurality of resources and an apparatus for controlling the resource sharing schedule, the method comprising:
initializing a resource status for each resource and for each operation mode, stored in a storage unit, and information for controlling the resource sharing schedule;
assigning a target resource when a source resource requests assignment of the target resource; and
updating the resource status stored in the storage unit when the source resource requests status update.

8. The method of claim 7, wherein the initializing a resource status and information for controlling the resource sharing schedule comprises:
setting operation statuses of all resource types and all resource status areas in the storage unit as off and setting a reservation status of a reservation area as off;
measuring an operation cycle for each of the all resource types and for each operation mode by defining the operation statuses of the resources,
recording a measured processing time;
recording a number of hops between the all resources; and
recording a transmission amount between the source resource and the target resource for each of the all resource types and for each operation mode.

9. The method of claim 7, wherein the assigning a target resource comprises:
receiving a request of assignment of the target resource from the source resource;
selecting a resource available for a shortest period during a decoding operation by checking the resource status stored in the storage unit;
reserving the selected resource; and
assigning the reserved resource to the target resource.

10. The method of claim 9, wherein the assigning a target resource further comprises outputting information on the target resource to the source resource when the resource status of the target resource is an immediately available status.

11. The method of claim 9, wherein, in the selecting a resource available for a shortest period during a decoding operation, when the reservation status is off, a resource whose having a least time obtained by adding an expected transmission time and an expected standby time, as the resource available for the shortest period.

12. The method of claim 11, wherein the expected transmission time is obtained by multiplying a distance between the source resource and the target resource, a transmission time for each of the hops, and transmission amounts recorded in a transmission amount recorder.

13. The method of claim 9, wherein the reserving the selected resource comprises:
setting a requested source resource a reserved source resource;
extracting an expected processing time of a requested operation mode from the storage unit and setting the extracted expected processing time as a reservation standby time; and
setting a reservation status of a reservation area of the storage unit as on.

14. The method of claim 7, wherein the updating the resource status stored in the storage unit comprises:
updating the resource status stored in the storage unit when a status of the source resource informs a beginning;
checking whether the source resource is a reserved resource when the status of the source resource informs an end;
outputting information on the target resource to the source resource when the source resource is the reserved resource; and
updating the resource status stored in the storage unit when the source resource is not the reserved resource.
